(19) United States
(12) Patent Application Publication
(10) Pub. No.: US 2012/0064278 A1
(43) Pub. Date: Mar. 15, 2012

(54) PACKAGE OF ENVIRONMENTAL SENSITIVE ELEMENT AND ENCAPSULATION METHOD THEREOF

(75) Inventor: Kuang-Jung Chen, Hsinchu County (TW)

(73) Assignee: INDUSTRIAL TECHNOLOGY RESEARCH INSTITUTE, Hsinchu (TW)

(21) Appl. No.: 12/915,018

(22) Filed: Oct. 29, 2010

(30) Foreign Application Priority Data
Sep. 10, 2010 (TW) 99130696

(51) Int. Cl. B32B 33/00; B44C 1/22; B32B 3/02

(52) U.S. Cl. 428/76; 156/313; 156/242; 216/33

(57) ABSTRACT

A package of environmental sensitive element including a first substrate, a second substrate, an environmental sensitive element and a filler is provided. The second substrate is disposed above the first substrate and has a first barrier structure. The first barrier structure is located between the first substrate and the second substrate. The first barrier structure and the second substrate are integrally formed and made of the same material. The environmental sensitive element is disposed on the first substrate and located between the first substrate and the second substrate. The first barrier structure surrounds the environmental sensitive element. The filler is disposed between the first substrate and the second substrate and covers the environmental sensitive element and the first barrier structure.

### CROSS-REFERENCE TO RELATED APPLICATION

This application claims the priority benefit of Taiwan application serial no. 99130696, filed on Sep. 10, 2010. The entirety of the above-mentioned patent application is hereby incorporated by reference herein and made a part of this specification.

### BACKGROUND

1. Field of the Application

The disclosure relates to a package and an encapsulation method thereof, and more particularly to a package of an environmental sensitive element and an encapsulation method thereof.

2. Related Art

Flexible substrates have a wider application comparing to conventional rigid substrates. Flexible substrates are advantageous for their flexibility, portability, safety standard satisfaction, and wide product application. However, disadvantages of flexible substrates include high temperature intolerance, poor water and oxygen resistance, poor chemical resistance, and large thermal expansion coefficient. Typical flexible substrates can not block the permeation of vapor and oxygen completely, such that the devices inside the substrates are deteriorated rapidly. Consequently, the devices manufactured have reduced lifespan and can not meet commercial demands.

In order to solve the issues aforementioned, several conventional technologies are provided such as Taiwan Patent No. 570472m 200603416 (GE), U.S. Pat. Nos. 6,576,351, 6,866,901, 2005/0249901, 2006/0226523, 2007/0172971, 2008/0006819.

In Taiwan Patent No. 570472, an improved flexible photoelectric device package structure is disclosed. In this method, a glue material with a high adhesion coefficient and a nano-inorganic material mixture are added to a sealant of a non-display region of the photoelectric device. However, the water resistance and oxygen permeability of this structure is poor comparing to those of a multi-layer stacked structure including metal layers and organic layers or a multi-layer stacked structure including inorganic layers and organic layers. Moreover, the flexible reliability of the sealant adhesion method is poor comparing to that of entire adhesion method.

In Taiwan Patent No. 200603416, an organic electronic package having a sealed edge and a manufacturing method thereof are disclosed. Here, the edge of the device is covered by the water and oxygen resistant surface plate and a sealant. As the edge is covered by the water and oxygen resistant surface plate using a glue material, water and oxygen can permeate into the device through the edge sealant.

### SUMMARY

A package of an environmental sensitive element and a manufacturing method thereof are introduced herein to improve the problem of reduced lifespan of electronic devices due to the permeation of vapor and oxygen.

A package of an environmental sensitive element is introduced. The package includes a first substrate, a second substrate, an environmental sensitive element, and a filler. The second substrate is disposed above the first substrate. The second substrate has a first barrier structure. The first barrier structure is located between the first substrate and the second substrate. The first barrier structure and the second substrate are integrally formed and made of a same material. The environmental sensitive element is disposed on the first substrate and located between the first substrate and the second substrate. The first barrier structure surrounds the environmental sensitive element. The filler is disposed between the first substrate and the second substrate and covers the environmental sensitive element and the first barrier structure.

A package of an environmental sensitive element is further introduced. The package includes a first substrate, a second substrate, an environmental sensitive element, and a filler. The first substrate has a first barrier structure, where the first barrier structure and the first substrate are integrally formed and made of a same material. The second substrate is disposed above the first substrate. The first barrier structure is located between the first substrate and the second substrate. The environmental sensitive element is disposed on the first substrate and located between the first substrate and the second substrate. The first barrier structure surrounds the environmental sensitive element. The filler is disposed between the first substrate and the second substrate and covers the environmental sensitive element and the first barrier structure.

An encapsulation method of an environmental sensitive element is introduced herein. The method includes the following. An environmental sensitive element is formed on a first substrate. A second substrate and a first barrier structure that are integrally formed are provided on the first substrate. The first barrier structure surrounds the environmental sensitive element. The first barrier structure and the second substrate are substantially made of a same material. A filler is formed on the second substrate to cover the first barrier structure. The second substrate is pressed onto the first substrate, such that the second substrate adheres to the first substrate through the filler and the filler covers the environmental sensitive element.

An encapsulation method of an environmental sensitive element is further introduced. The method includes the following. A first substrate and a first barrier structure that are integrally formed are provided. The first barrier structure and the first substrate are substantially made of a same material. An environmental sensitive element is formed on the first substrate, where the first barrier structure surrounds the environmental sensitive element. A filler is formed on the first substrate to cover the environmental sensitive element and the first barrier structure. A second substrate is provided on the first substrate. The second substrate is pressed onto the filler.

In light of the foregoing, as a substrate of the disclosure has an integrally formed barrier structure, the barrier structure surrounds an environmental sensitive element. Here, the barrier structure and the substrate are made of a same material (i.e. stainless steel). Thus, the package of the environmental sensitive element of the disclosure has superior vapor and oxygen resistance and can extend the lifespan of the environmental sensitive element effectively.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIGS. 1A to 1E are schematic diagrams illustrating a flow chart of an encapsulation method of an environmental sensitive element according to an exemplary embodiment.

FIG. 2 is a schematic cross-sectional view of a package of an environmental sensitive element according to an exemplary embodiment.

FIG. 3 is a schematic cross-sectional view of a package of an environmental sensitive element according to another exemplary embodiment.

FIG. 4 is a schematic cross-sectional view of a package of an environmental sensitive element according to another exemplary embodiment.

FIG. 5 is a schematic cross-sectional view of a package of an environmental sensitive element according to another exemplary embodiment.

FIGS. 6A to 6D are schematic diagrams illustrating a flow chart of an encapsulation method of an environmental sensitive element according to an exemplary embodiment.

FIG. 7 is a schematic cross-sectional view of a package of an environmental sensitive element according to an exemplary embodiment.

FIG. 8 is a schematic cross-sectional view of a package of an environmental sensitive element according to another exemplary embodiment.

FIG. 9 is a schematic cross-sectional view of a package of an environmental sensitive element according to another exemplary embodiment.

FIG. 10 is a schematic cross-sectional view of a package of an environmental sensitive element according to another exemplary embodiment.

### DESCRIPTION OF EMBODIMENTS

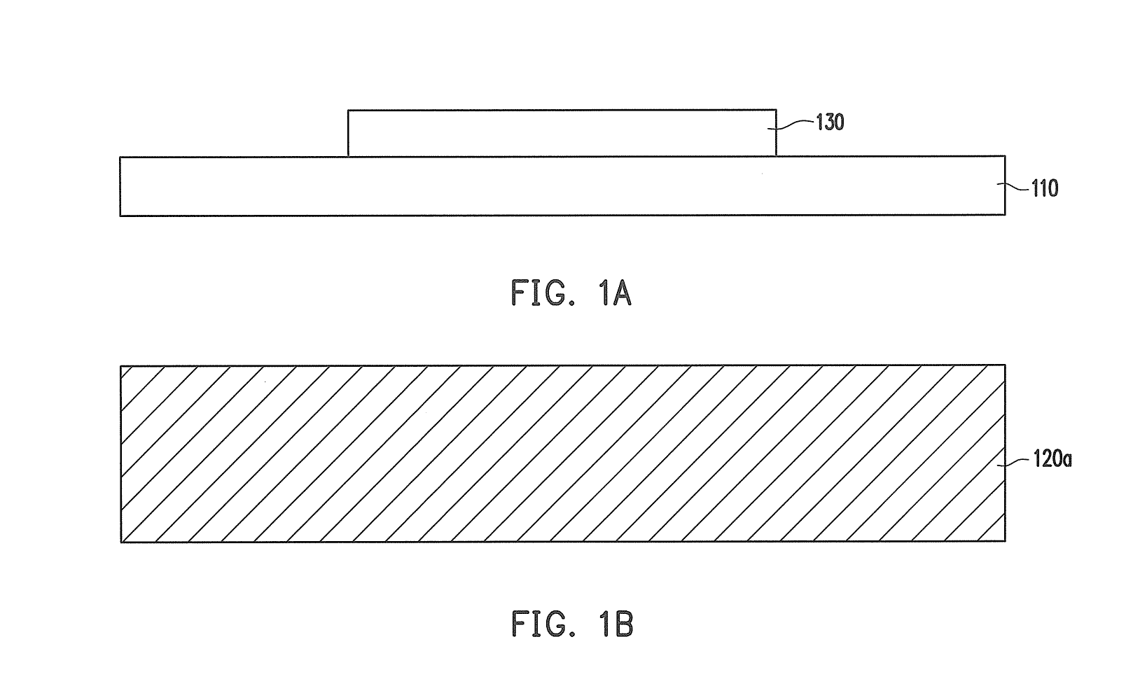

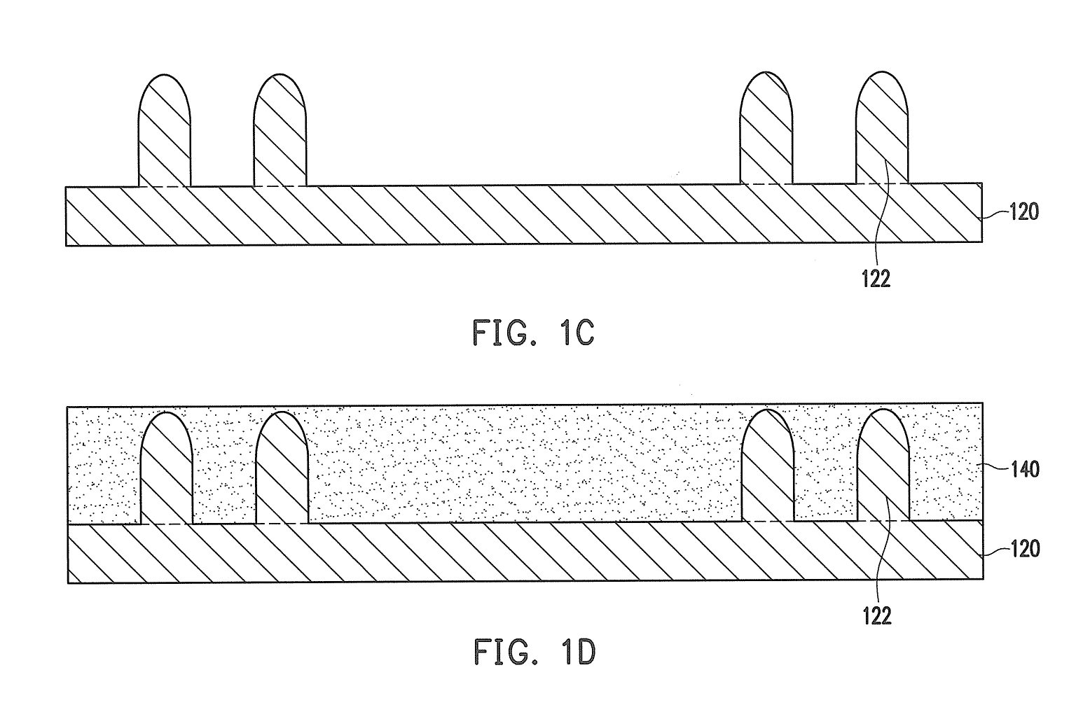

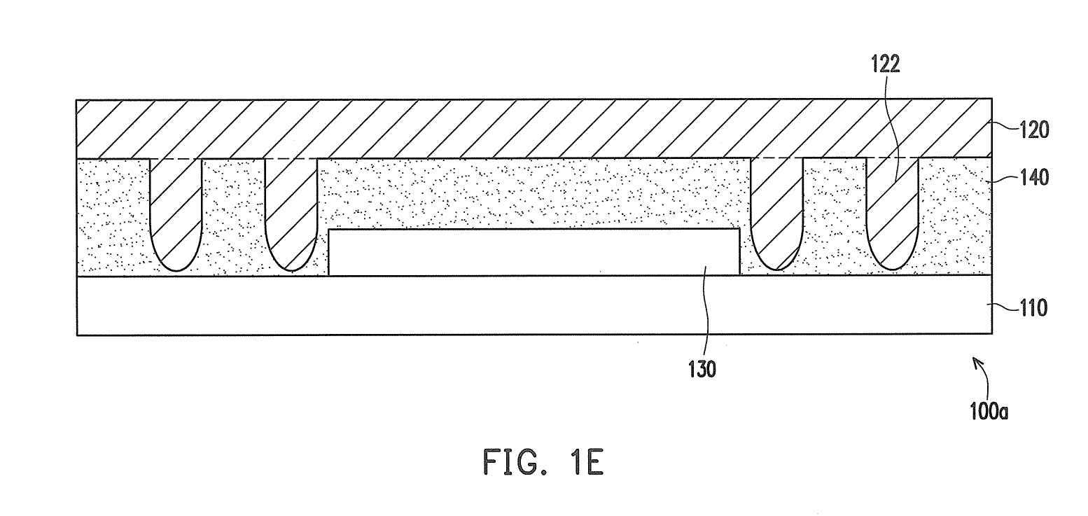

FIGS. 1A to 1E are schematic diagrams illustrating a flow chart of an encapsulation method of an environmental sensitive element according to an exemplary embodiment. Referring to FIG. 1A, an encapsulation method of an environmental sensitive element of the present exemplary embodiment includes the following. An environmental sensitive element 130 is formed on a first substrate 110. The first substrate 110 is, for example, a flexible substrate made of polyethylene terephthalate (PET), polyethylene naphthalene (PEN), polyethersulfone (PES), polymethylmethacrylate (PMMA), polycarbonate (PC), polyimide (PI), or metal foil. The flexible substrate can also be a substrate having a touch screen function, for example, a surface capacitive touch screen, a digital matrix touch screen (i.e. a projective capacitive touch screen), or an analogue matrix touch screen.

The environmental sensitive element 130 is, for instance, an active environmental sensitive element display device or a passive environmental sensitive element display device. Here, the active environmental sensitive element display device is, for example, an active matrix organic light emitting diode (AM-OLED), an active matrix electrophoretic display (AM-EPD), the so-called electronic paper, an active matrix liquid crystal display (AM-LCD), or an active matrix blue phase liquid crystal display. The passive environmental sensitive element display device is, for example, a passive matrix organic light emitting diode (PM-OLED) or a super twisted nematic liquid crystal display (STN-LCD).

Referring to FIG. 1B, a substrate 120a is provided. The substrate 120a is made of stainless steel, glass, or plastic, for example.

Referring to FIG. 1C, for instance, when the substrate 120a is made of stainless steel or glass, an etching process is performed to the substrate 120 to form a second substrate 120 and a plurality of first barrier structures 122 located on the second substrate 120. When the substrate 120a is made of plastic, a molding process or a pressing process is performed to the substrate 120a to form the second substrate 120 and the first barrier structures 122 located on the second substrate 120. That is, the first barrier structures 122 and the second substrate 120 of the present exemplary embodiment are integrally formed and made of the same material. It should be illustrated that in the present exemplary embodiment, the substrate 120a shown in FIG. 1C is made of stainless steel as an example.

Notably, the present exemplary embodiment does not limit the number of the first barrier structures 122. However, two first barrier structures 122 are mentioned herein. In other exemplary embodiments not illustrated here, the number of the first barrier structures 122 can be more or less depending on demands. That is, the number of the first barrier structures can be one or more than two. As long as the number of the first barrier structures 122 is capable of attaining the structural design for vapor and oxygen resistance, and the number of the first barrier structures 122 is applicable to the technology of the disclosure and does not depart from the protection scope of the disclosure.

Referring to FIG. 1D, a filler 140 is formed on the second substrate 120. The filler 140 covers the first barrier structures 122. In the present exemplary embodiment, the filler 140 is made of acrylic or epoxy, for instance. The filler 140 is a pressure-sensitive material or a filler material, for instance.

Referring to FIG. 1E, the second substrate 120 is pressed onto the first substrate 110, so that the second substrate 120 is adhered to the first substrate 110 through the filler 140. The first barrier structures 122 surround the environmental sensitive element 130. The filler 140 covers the environmental sensitive element 130. Up to this point, the manufacture of a package 100 of an environmental sensitive element is completed.

In short, the encapsulation method of the environmental sensitive element in the present exemplary embodiment adopts stainless steel, glass, or plastic in the integrally formed second substrate 120 and the first barrier structures 122. Here, stainless steel or glass can have superior vapor and oxygen resistance without an additional barrier layer, and the first barrier structures 122 surround the environmental sensitive element 130. Thus, the package 100a of the environmental sensitive element adopting the method of the present exemplary embodiment has superior vapor and oxygen resistance and can extend the lifespan of the environmental sensitive element 130 effectively.

Obviously, the manufacture depicted in FIGS. 1A to 1E merely illustrates an example and some steps therein are common techniques applied in conventional packaging processes. Thus, persons skilled in the art can adjust, omit, or add steps according to actual circumstances to satisfy manufacturing demands, and the details are not repeated hereinafter.

Several exemplary embodiments are presented below to describe a package of an environmental sensitive element and a manufacturing method thereof. Notably, the exemplary embodiments provided below adopt notations and partial content of the exemplary embodiment aforementioned. Herein, identical notations are used to denote identical or similar elements and the description of identical technology is omitted. The omitted part can be referred to the above exemplary embodiment and is not repeated hereinafter.

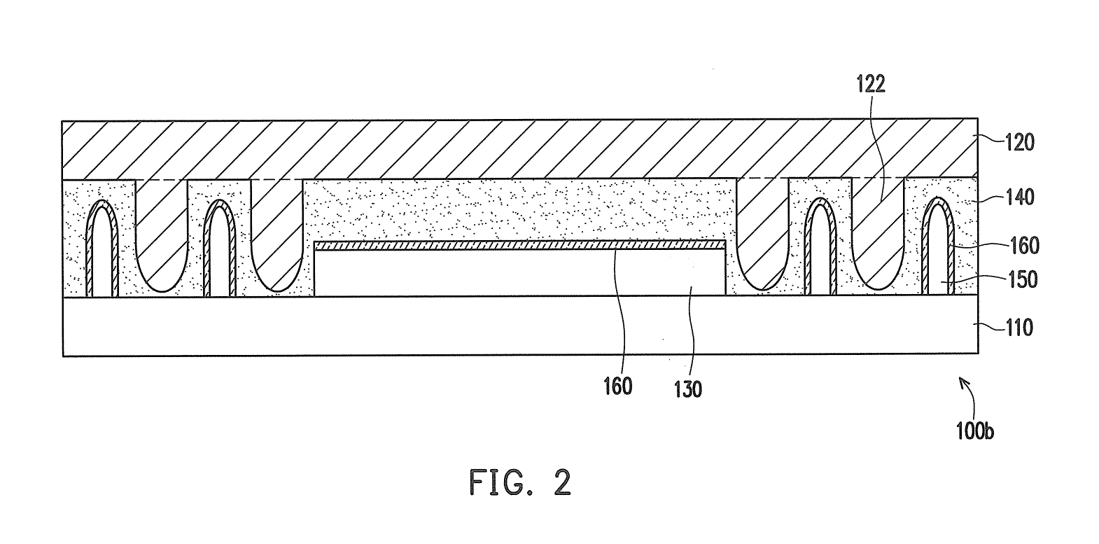

FIG. 2 is a schematic cross-sectional view of a package of an environmental sensitive element according to an exemplary embodiment. Referring to FIG. 2, a package 100b of an environmental sensitive element of FIG. 2 is similar to the package 100a of the environmental sensitive element of FIG. 1E. The difference between the two is that the package 100b of the environmental sensitive element in FIG. 2 further includes a plurality of second barrier structures 150 and a first passivation layer 160.

In details, in the present exemplary embodiment, the second barrier structures 150 are disposed on the first substrate 110 and surround the environmental sensitive element 130. The second barrier structures 150 and the first barrier structures 122 are arranged alternately. The first passivation layer 160 is disposed on the environmental sensitive element 130 and the second barrier structures 150. The first passivation layer 160 covers the second barrier structures 150 and is made of silicon nitride (SiNx), silicon oxide (SiOx), aluminum (Al), aluminum oxide (Al₂O₃), molybdenum oxide (MoO₃), or tungsten oxide (WO₃). As the first passivation layer 160 of the present exemplary embodiment covers the second barrier structures 150, the vapor and oxygen resistance of the package 100b of the environmental sensitive element is enhanced and the lifespan of the environmental sensitive element 130 is extended effectively.

As for the manufacture, the package 100b of the environmental sensitive element of the present exemplary embodiment adopts a manufacturing method similar to that of the package 100a of the environmental sensitive element in FIG. 1E. After the step illustrated in FIG. 1A, that is, after the environmental sensitive element 130 is formed on the first substrate 110, the second barrier structures 150 are formed on the first substrate 110. The passivation layer 160 is simultaneously formed on the environmental sensitive element 130 and the second barrier structures 150. The manufacture of the package 100a of the environmental sensitive element is generally completed after the steps in FIGS. 1B to 1E have been sequentially performed.

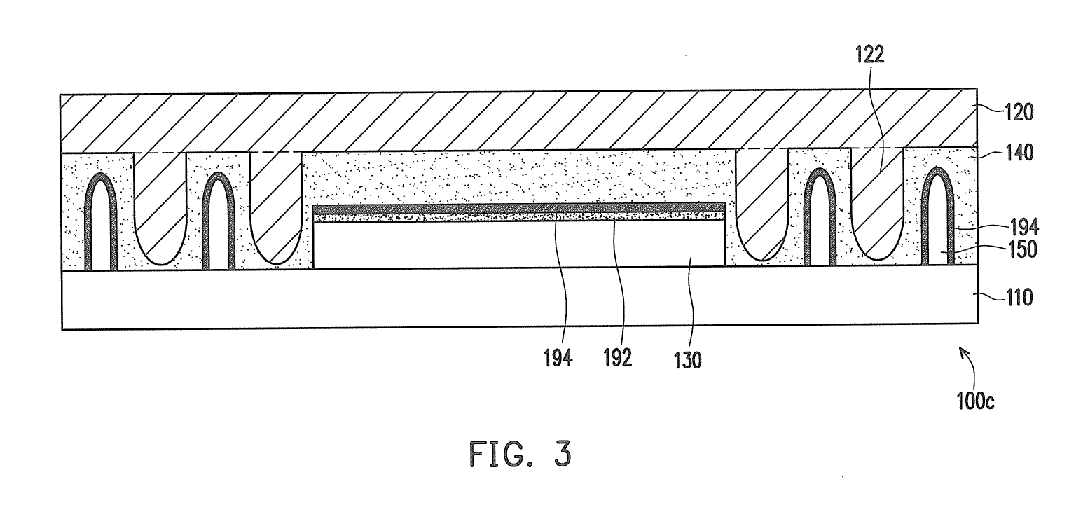

FIG. 3 is a schematic cross-sectional view of a package of an environmental sensitive element according to another exemplary embodiment. Referring to FIG. 3, a package 100c of an environmental sensitive element in FIG. 3 is similar to the package 100a of the environmental sensitive element in FIG. 1E. The difference is that the package 100c of the environmental sensitive element in FIG. 3 further includes a plurality of second barrier structures 150 and a flexible sacrificial layer 192. The flexible sacrificial layer 192 is made of small molecular compounds, oligomers, metals, or organic-inorganic co-steaming materials, for example. The molecular weight of the small molecular compounds approximately ranges from 10 g/mol to 5,000 g/mol. The small molecular compounds include, for example, Tris-(8-hydroxyquinoline)aluminum, alpha-NPB, N,N′-Dis(naphthalene-1-yl)-N,N′-diphenyl-benzidine, CuPc Phalocyanine, and copper complex. The molecular weight of the oligomers approximately ranges from 500 g/mol to 9,000 g/mol. The oligomers include phenylene vinylene oligomers, and fluorine oligomers, for instance. The molecular weight of the metal or organic-inorganic co-steaming materials ranges from 3 g/mol to 500 g/mol. A flexible passivation layer 194 is further included. The flexible passivation layer 194 is made of, for instance, indium tin oxide (ITO), indium zinc oxide (IZO), aluminum doped zinc oxide (AZO), tungsten oxide (WO₃), molybdenum oxide (MoO₃), silicon oxide (SiOx), silicon nitride (SiNx), silicon oxynitride (SiOₓN_{y}), aluminum oxide (Al₂O₃), aluminum (Al), argentum (Ag), magnesium-argentum (Mg—Ag), or magnesium-aluminum (Mg—Al).

In details, in the present exemplary embodiment, the second barrier structures 150 are disposed on the first substrate 110 and surround the environmental sensitive element 130. The second barrier structures 150 and the first barrier structures 122 are arranged alternately. The flexible sacrificial layer 192 is disposed on the environmental sensitive element 130. The flexible passivation layer 104 is disposed on the flexible sacrificial layer 192 and the second barrier structures 150. The flexible sacrificial layer 192 is located between the environmental sensitive element 130 and the flexible passivation layer 194. The flexible passivation layer 194 covers the second barrier structures 150.

As for the manufacture, the package 100c of the environmental sensitive element of the present exemplary embodiment adopts a manufacturing method similar to that of the package 100a of the environmental sensitive element in FIG. 1E. After the step illustrated in FIG. 1A, that is, after the environmental sensitive element 130 is formed on the first substrate 110, the second barrier structures 150 are formed on the first substrate 110. The flexible sacrificial layer 192 is disposed on the environmental sensitive element 130. The flexible passivation layer 194 is simultaneously formed on the flexible sacrificial layer 192 and the second barrier structures 150. The manufacture of the package 100c of the environmental sensitive element is generally completed after the steps in FIGS. 1B to 1E have been sequentially performed.

In the present exemplary embodiment, the flexible sacrificial layer 192 is manufactured on the environmental sensitive element 130. Thus, when the environmental sensitive element 130 is flexed, the film peeling phenomenon results in the flexible sacrificial layer 192. As a consequence, the film peeling resulted from the flexed environmental sensitive element 130 is improved, such that the light emitting structure is prevented from being damaged when the element is flexed. The product yield is therefore enhanced effectively. In addition, as the flexible passivation layer 194 of the present exemplary embodiment covers the second barrier structures 150, the vapor and oxygen resistance of the package 100c of the environmental sensitive element is enhanced and the lifespan of the environmental sensitive element 130 is extended effectively.

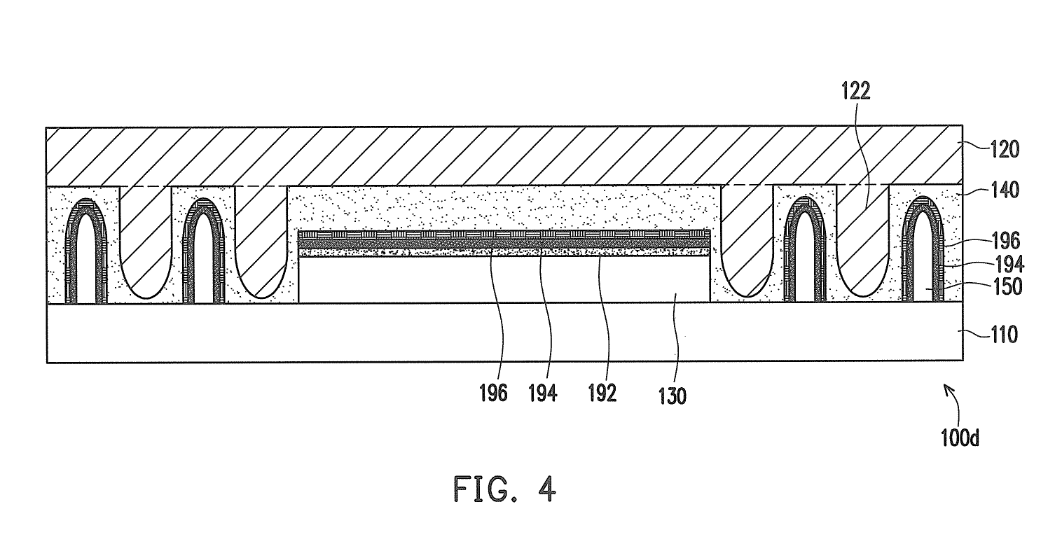

FIG. 4 is a schematic cross-sectional view of a package of an environmental sensitive element according to another exemplary embodiment. Referring to FIG. 4, a package 100d of an environmental sensitive element of FIG. 4 is similar to the package 100c of the environmental sensitive element of FIG. 3. The difference between the two is that the package 100d of the environmental sensitive element in FIG. 4 further includes a plurality of passivation films 196. Specifically, the passivation films 196 are disposed on the flexible passivation layer 194. The passivation films 196 cover a portion of the flexible passivation layer 194 located on the second barrier structures 150. As the second barrier structures 150 are covered by the passivation films 196 and the flexible passivation layer 194, the vapor and oxygen resistance of the package 100d of the environmental sensitive element is enhanced and the lifespan of the environmental sensitive element 130 is extended effectively.

As for the manufacture, the package 100d of the environmental sensitive element of the present exemplary embodiment adopts a manufacturing method similar to that of the package 100c of the environmental sensitive element in FIG. 3. After the flexible passivation layer 194 is simultaneously formed on the flexible sacrificial layer 192 and the second barrier structures 150, the passivation films 196 are formed on the flexible passivation layer 194 at the same time. The passivation films 196 cover a portion of the flexible passivation layer 194 located on the second barrier structures 150. The manufacture of the package 100d of the environmental sensitive element is generally completed after the steps in FIGS. 1B to 1E have been sequentially performed.

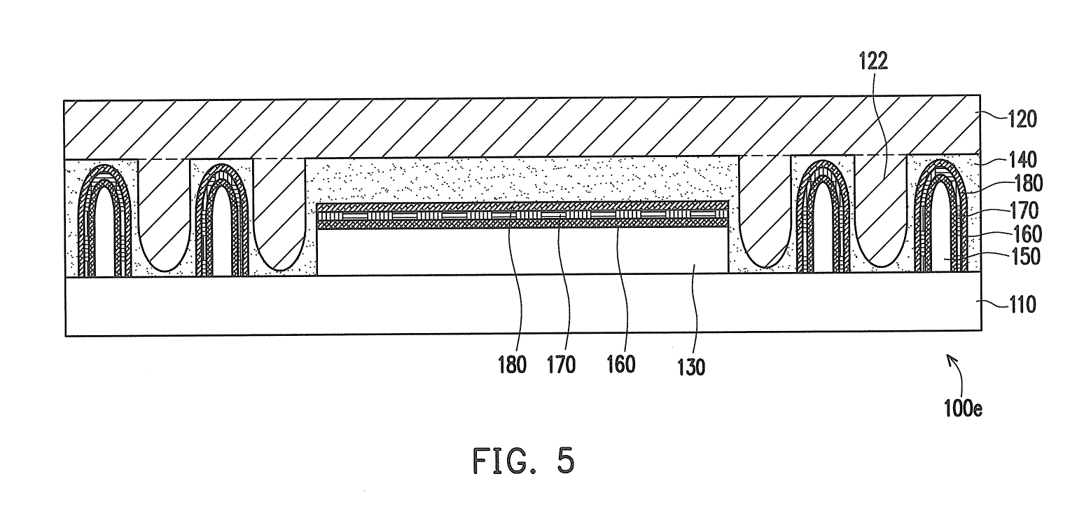

FIG. 5 is a schematic cross-sectional view of a package of an environmental sensitive element according to another exemplary embodiment. Referring to FIG. 5, a package 100e of an environmental sensitive element of FIG. 5 is similar to the package 100a of the environmental sensitive element of FIG. 1E. The difference between the two is that the package 100e of the environmental sensitive element in FIG. 5 further includes a plurality of second barrier structures 150, a first passivation layer 160, an absorbent layer 170, and a second passivation layer 180.

In details, in the present exemplary embodiment, the second barrier structures 150 are disposed on the first substrate 110 and surround the environmental sensitive element 130. The second barrier structures 150 and the first barrier structures 122 are arranged alternately. The first passivation layer 160 is disposed on the environmental sensitive element 130 and the second barrier structures 150. The first passivation layer 160 covers the second barrier structures 150. The absorbent layer 170 is disposed on the first passivation layer 160. The absorbent layer 170 covers the first passivation layer 160 located on the environmental sensitive element 130 and the first passivation layer 160 located on the second barrier structures 150. The second passivation layer 180 is disposed on the absorbent layer 170. The absorbent layer 170 is located between the first passivation layer 160 and the second passivation layer 180.

In short, the second barrier structures 150 of the present exemplary embodiment are covered with the first passivation layer 160, the absorbent layer 170, and the second passivation layer 180 sequentially. As the second barrier structures 150 of the present exemplary embodiment are sequentially covered with the first passivation layer 160, the absorbent layer 170, and the second passivation layer 180, the vapor and oxygen resistance of the package 100e of the environmental sensitive element is enhanced and the lifespan of the environmental sensitive element 130 is extended effectively.

As for the manufacture, the package 100e of the environmental sensitive element of the present exemplary embodiment adopts a manufacturing method similar to that of the package 100a of the environmental sensitive element in FIG. 1E. After the step illustrated in FIG. 1A, that is, after the environmental sensitive element 130 is formed on the first substrate 110, the second barrier structures 150 are formed on the first substrate 110. The first passivation layer 160 is simultaneously formed on the environmental sensitive element 130 and the second barrier structures 150. The absorbent layer 170 is formed on the first passivation layer 160. The second passivation layer 180 is disposed on the absorbent layer 170. The absorbent layer 170 is located between the first passivation layer 160 and the second passivation layer 180. The manufacture of the package 100e of the environmental sensitive element is generally completed after the steps in FIGS. 1B to 1E have been sequentially performed.

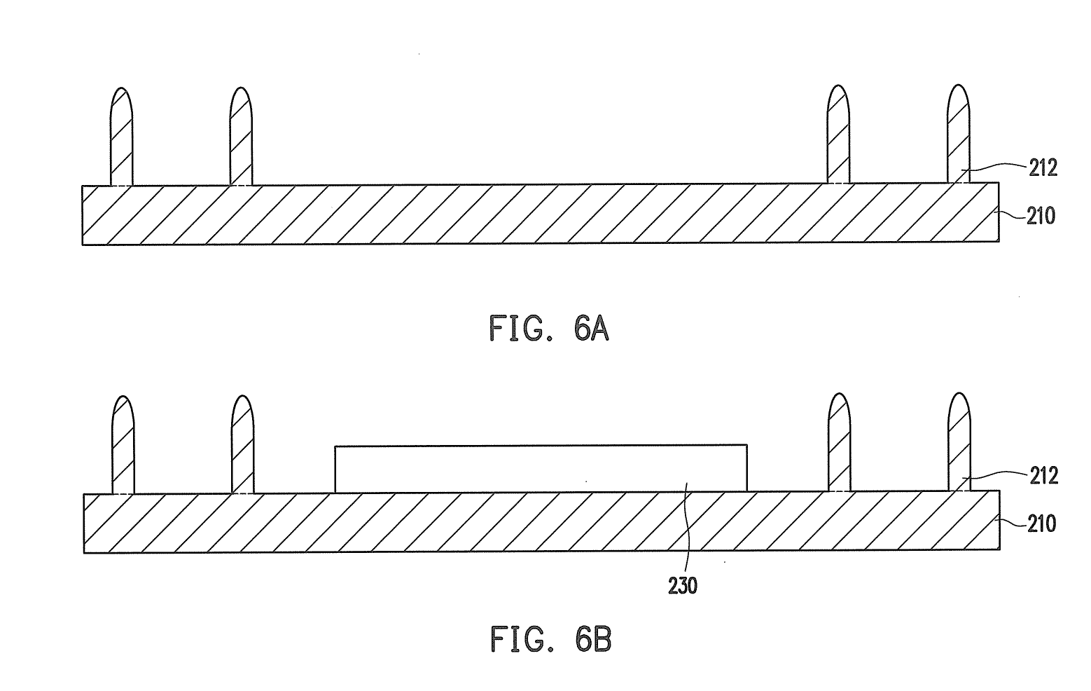

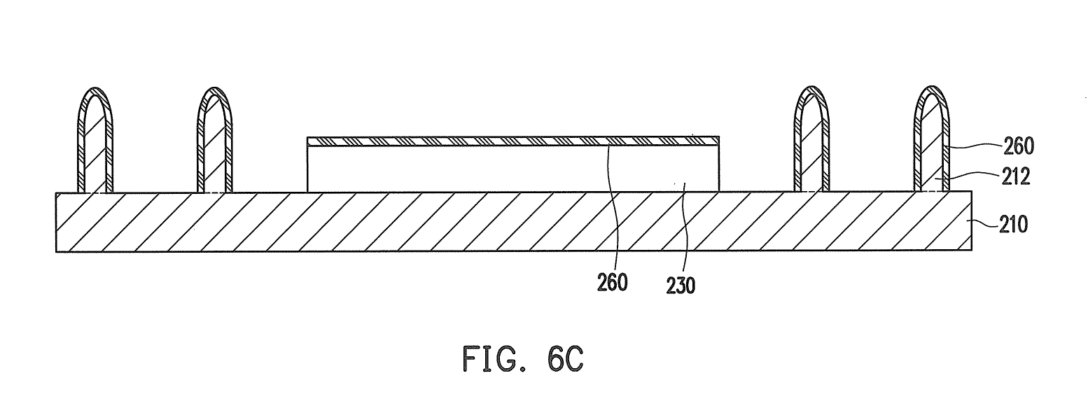

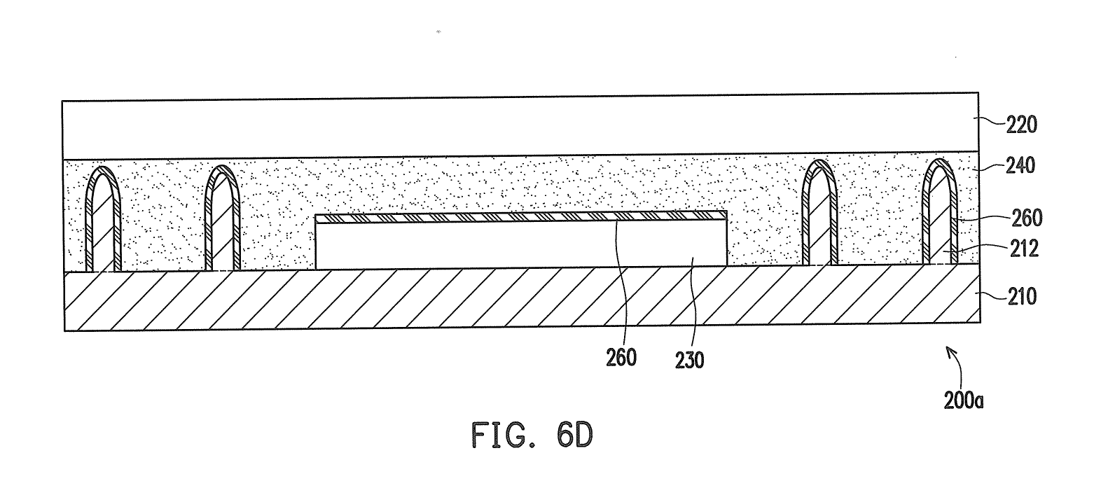

FIGS. 6A to 6D are schematic diagrams illustrating a flow chart of an encapsulation method of an environmental sensitive element according to an exemplary embodiment. Referring to FIG. 6A, an encapsulation method of an environmental sensitive element of the present exemplary embodiment includes the following. A first substrate 210 and a first barrier structure 212 that are integrally formed are provided. The first barrier structure 212 and the first substrate 210 are substantially made of a same material, such as stainless steel, glass, or plastic.

In the present exemplary embodiment, when the first substrate 210 is made of stainless steel or glass, the step of forming the first substrate 210 and the first barrier structure 212 includes the following. For example, a substrate (not illustrated) is provided. An etching process is performed to the substrate to form the first substrate 210 and a plurality of first barrier structures 212 located on the first substrate 210. When the first substrate 210 is made of plastic, the step of forming the first substrate 210 and the first barrier structure 212 includes the following. For example, a substrate (not illustrated) is provided. A molding process or a pressing process is performed to the substrate to form the first substrate 210 and a plurality of first barrier structures 212 located on the first substrate 210.

Referring to FIG. 6B, an environmental sensitive element 230 is formed on the first substrate 210, where the first barrier structures 212 surround the environmental sensitive element 230. In the present exemplary embodiment, the environmental sensitive element 230 is, for instance, an active environmental sensitive element display device or a passive environmental sensitive element display device. Here, the active environmental sensitive element display device is, for example, an AM-OLED, an AM-EPD, the so-called electronic paper, an AM-LCD, or an active matrix blue phase liquid crystal display. The passive environmental sensitive element display device is, for example, a PM-OLED or a STN-LCD.

Referring to FIG. 6C, a first passivation layer 260 is formed on the environmental sensitive element 230 and the first barrier structures 212. The first passivation layer 230 covers the first barrier structures 212. In the present exemplary embodiment, the first passivation layer 230 is made of silicon nitride (SiNx), silicon oxide (SiOx), aluminum (Al), aluminum oxide (Al₂O₃), molybdenum oxide (MoO₃), or tungsten oxide (WO₃).

Referring to FIG. 6D, a filler 240 is formed on the first substrate 210. The filler 240 covers the environmental sensitive element 230 and the first barrier structures 212. In the present exemplary embodiment, the filler 240 is made of acrylic or epoxy, for instance. The filler 240 is a pressure-sensitive material or a filler material, for instance.

Referring to FIG. 6D, a second substrate 220 is provided on the first substrate 210. The second substrate 220 is pressed onto the filler 240. The second substrate 220 is adhered to the first substrate 210 through the filler 240. In the present exemplary embodiment, the second substrate 220 is, for example, a flexible substrate made of PET, PEN, PES, PMMA, PC, PI, or metal foil. The flexible substrate can also be a substrate having a touch screen function, for example, a surface capacitive touch screen, a digital matrix touch screen (i.e. a projective capacitive touch screen), or an analogue matrix touch screen. Up to this point, the manufacture of a package 200a of an environmental sensitive element is completed.

In short, the encapsulation method of the environmental sensitive element in the present exemplary embodiment adopts stainless steel, glass, or plastic in the integrally formed first substrate 210 and the first barrier structures 212. Here, stainless steel or glass can have superior vapor and oxygen resistance without an additional barrier layer, and the first barrier structures 212 surround the environmental sensitive element 230. Thus, the package 200a of the environmental sensitive element adopting the method of the present exemplary embodiment has superior vapor and oxygen resistance and can extend the lifespan of the environmental sensitive element 230 effectively.

Obviously, the manufacture depicted in FIGS. 6A to 6D merely illustrates an example and some steps therein are common techniques applied in conventional packaging processes. Thus, persons skilled in the art can adjust, omit, or add steps according to actual circumstances to satisfy manufacturing demands, and the details are not repeated hereinafter.

Several exemplary embodiments are presented below to describe a package of an environmental sensitive element and a manufacturing method thereof. Notably, the exemplary embodiments provided below adopt notations and partial content of the exemplary embodiments aforementioned. Herein, identical notations are used to denote identical or similar elements and the description of identical technology is omitted. The omitted part can be referred to the above exemplary embodiment and is not repeated hereinafter.

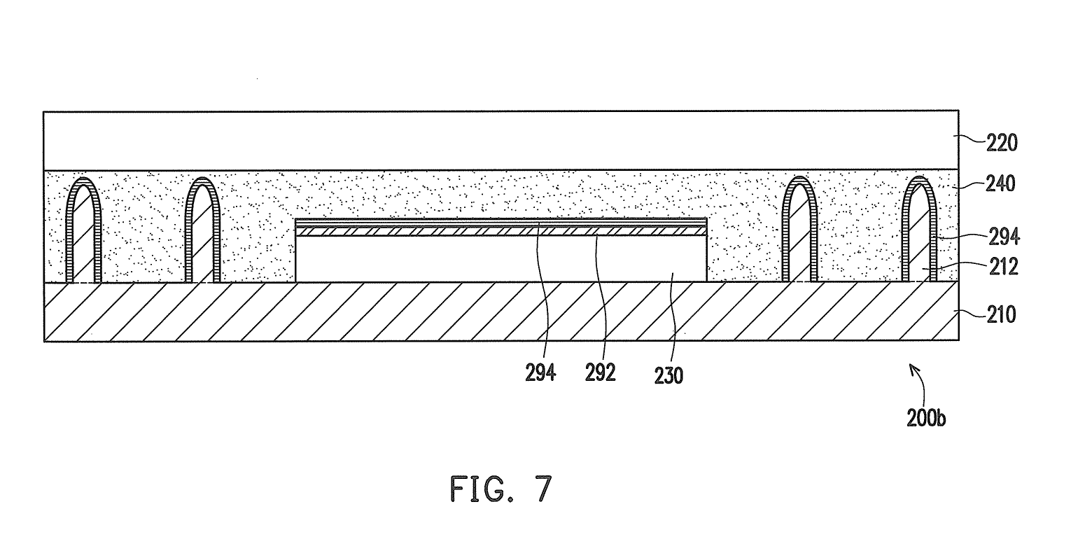

FIG. 7 is a schematic cross-sectional view of a package of an environmental sensitive element according to an exemplary embodiment. Referring to FIG. 7, a package 200b of an environmental sensitive element of FIG. 7 is similar to the package 200a of the environmental sensitive element of FIG. 6D. The difference between the two is that the package 200b of the environmental sensitive element in FIG. 7 further includes a flexible sacrificial layer 292 and a flexible passivation layer 294.

In details, in the present embodiment, the flexible sacrificial layer 292 is disposed on the environmental sensitive element 230. The flexible passivation layer 294 is disposed on the flexible sacrificial layer 292 and the first barrier structures 212. The flexible sacrificial layer 292 is located between the environmental sensitive element 230 and the flexible passivation layer 294. The flexible passivation layer 294 covers the first barrier structures 212.

As for the manufacture, the package 200b of the environmental sensitive element of the present exemplary embodiment adopts a manufacturing method similar to that of the package 200a of the environmental sensitive element in FIG. 6D. After the step illustrated in FIG. 6B, that is, after the environmental sensitive element 230 is formed on the first substrate 210, the flexible sacrificial layer 292 is formed on the environmental sensitive element 230. The flexible passivation layer 294 is simultaneously formed on the flexible sacrificial layer 292 and the first barrier structures 212. Thereafter, the step of FIG. 6D is performed so as to complete the manufacture of the package 200b of the environmental sensitive element.

In the present exemplary embodiment, the flexible sacrificial layer 292 is manufactured on the environmental sensitive element 230. Thus, when the environmental sensitive element 230 is flexed, the film peeling phenomenon results in the flexible sacrificial layer 292. As a consequence, the film peeling resulted from the flexed environmental sensitive element 230 is improved, such that the light emitting structure is prevented from being damaged when the element is flexed. The product yield is therefore enhanced effectively. Further, as the metal passivation layer 294 of the present exemplary embodiment covers the first barrier structures 212, the vapor and oxygen resistance of the package 200b of the environmental sensitive element is enhanced and the lifespan of the environmental sensitive element 230 is extended effectively.

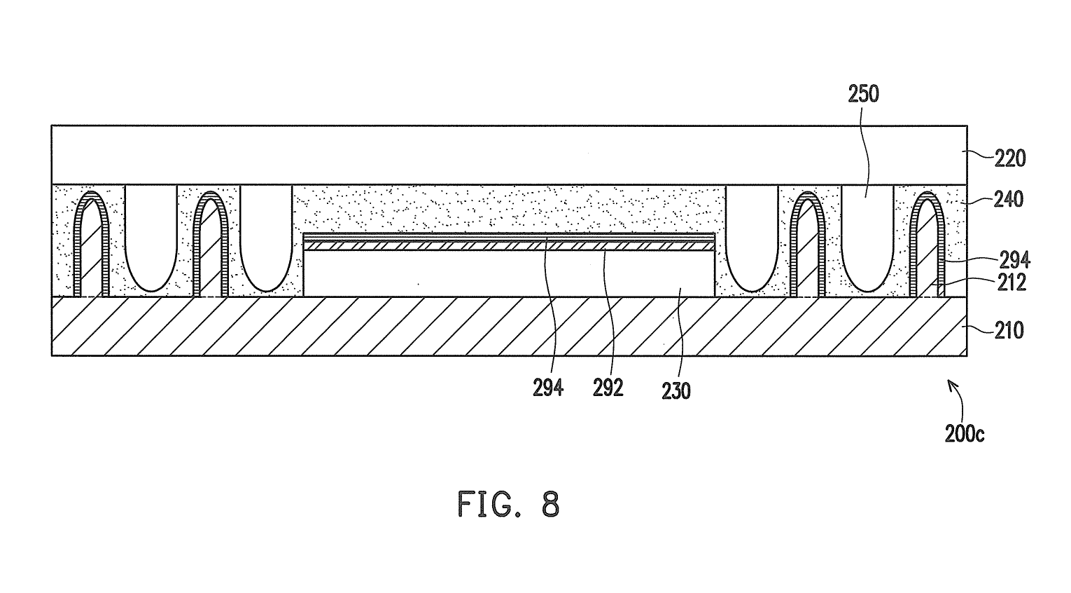

FIG. 8 is a schematic cross-sectional view of a package of an environmental sensitive element according to another exemplary embodiment. Referring to FIG. 8, a package 200c of an environmental sensitive element of FIG. 8 is similar to the package 200b of the environmental sensitive element of FIG. 7. The difference between the two is that the package 200b of the environmental sensitive element in FIG. 8 further includes a plurality of second barrier structures 250.

In details, in the present exemplary embodiment, the second barrier structures 150 are disposed on the first substrate 110 and surround the environmental sensitive element 130. The second barrier structures 150 and the first barrier structures 122 are arranged alternately. As for the manufacture, the package 200c of the environmental sensitive element of the present exemplary embodiment adopts a manufacturing method generally similar to that of the package 200b of the environmental sensitive element in FIG. 7. After the step illustrated in FIG. 6B, that is, after the environmental sensitive element 230 is formed on the first substrate 210, the second barrier structures 250 are formed on the second substrate 210. The flexible sacrificial layer 292 is formed on the environmental sensitive element 230 and the flexible passivation layer 294 is formed on the flexible sacrificial layer 292 and the first barrier structures 212. Thereafter, the step of FIG. 6D is performed so as to complete the manufacture of the package 200c of the environmental sensitive element.

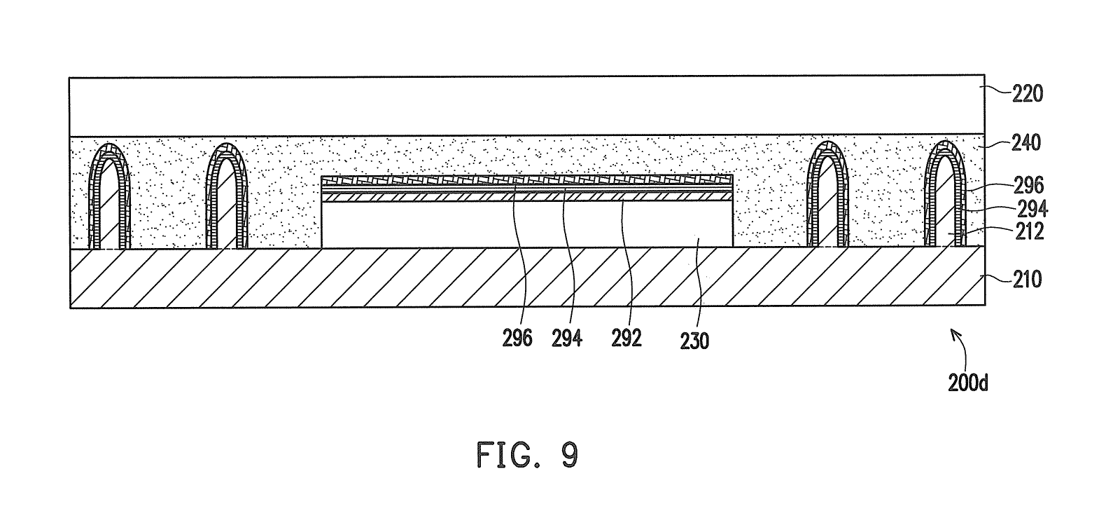

FIG. 9 is a schematic cross-sectional view of a package of an environmental sensitive element according to another exemplary embodiment. Referring to FIG. 9, a package 200d of an environmental sensitive element of FIG. 9 is similar to the package 200b of the environmental sensitive element of FIG. 7. The difference between the two is that the package 200d of the environmental sensitive element in FIG. 9 further includes a plurality of passivation films 296. In specific, the passivation films 296 are disposed on the flexible passivation layer 294. The passivation films 296 cover a portion of the flexible passivation layer 294 located on the first barrier structures 212. As the first barrier structures 212 are covered by the passivation films 296 and the flexible passivation layer 294, the vapor and oxygen resistance of the package 200d of the environmental sensitive element is enhanced and the lifespan of the environmental sensitive element 230 is extended effectively.

As for the manufacture, the package 200d of the environmental sensitive element of the present exemplary embodiment adopts a manufacturing method similar to that of the package 200b of the environmental sensitive element in FIG. 7. After the flexible passivation layer 294 is simultaneously formed on the flexible sacrificial layer 292 and the first barrier structures 212, the passivation films 296 are formed on the flexible passivation layer 294 at the same time. The passivation films 296 cover a portion of the flexible passivation layer 294 located on the first barrier structures 212. The step of FIG. 6D is then performed so as to complete the manufacture of the package 200d of the environmental sensitive element.

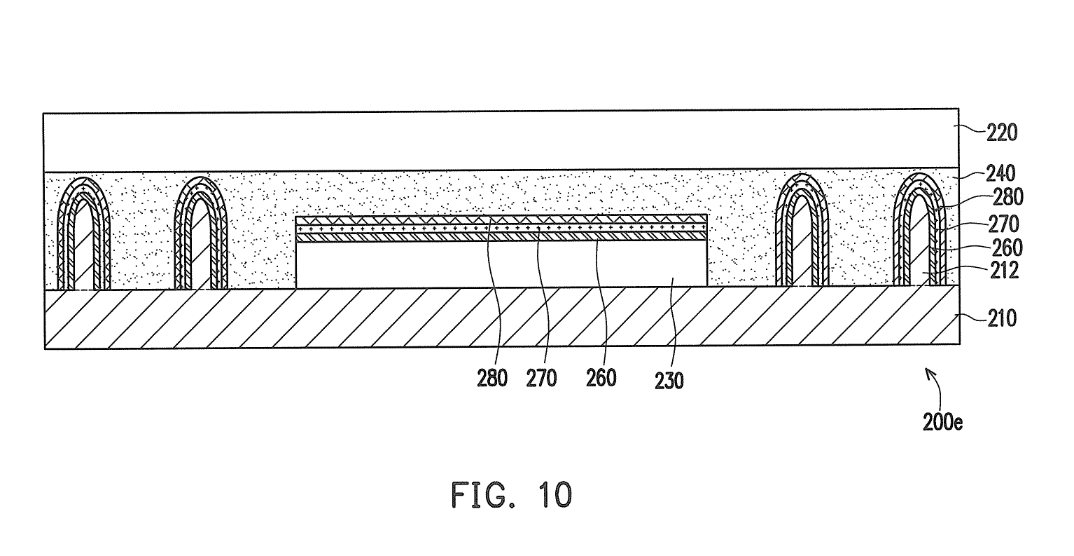

FIG. 10 is a schematic cross-sectional view of a package of an environmental sensitive element according to another exemplary embodiment. Referring to FIG. 10, a package 200e of an environmental sensitive element of FIG. 10 is similar to the package 200a of the environmental sensitive element of FIG. 6D. The difference between the two is that the package 200e of the environmental sensitive element in FIG. 10 further includes a getter layer 270 and a second passivation layer 280.

In the present exemplary embodiment, the getter layer 270 is disposed on the first passivation layer 260. The getter layer 270 covers the first passivation layer 260 located on the environmental sensitive element 230 and the first passivation layer 260 located on the first barrier structures 212. The second passivation layer 260 is disposed on the getter layer 270. The getter layer 270 is located between the first passivation layer 260 and the second passivation layer 280. As the first barrier structures 150 of the present exemplary embodiment are covered with the first passivation layer 260, the getter layer 270, and the second passivation layer 280 sequentially, the vapor and oxygen resistance of the package 200e of the environmental sensitive element is enhanced and the lifespan of the environmental sensitive element 230 is extended effectively.

As for the manufacture, the package 200e of the environmental sensitive element of the present exemplary embodiment adopts a manufacturing method similar to that of the package 200a of the environmental sensitive element in FIG. 6D. After the step illustrated in FIG. 6C, that is, after the first passivation layer 260 is formed on the environmental sensitive element 230 and the first barrier structures 212, the getter layer 270 is formed on the first substrate 260. The second passivation layer 280 is then formed on the getter layer 270. The getter layer 270 is located between the first passivation layer 260 and the second passivation layer 280. Later, the step of FIG. 6D is performed so as to complete the manufacture of the package 200e of the environmental sensitive element.

In summary, since a substrate in the disclosure has an integrally formed barrier structure, the barrier structure surrounds an environmental sensitive element. The barrier structure and the substrate both adopt stainless steel or glass with superior vapor and oxygen resistance, or plastic integrally formed with the barrier. Therefore, the package of the environmental sensitive element of the disclosure not only has superior vapor and oxygen resistance, but can also extend the lifespan of the environmental sensitive element effectively.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A package of an environmental sensitive element, the package comprising:
a first substrate;
a second substrate disposed above the first substrate and having a first barrier structure located between the first substrate and the second substrate, wherein the first barrier structure and the second substrate are integrally formed and substantially made of a same material;
an environmental sensitive element disposed on the first substrate and located between the first substrate and the second substrate, wherein the first barrier structure surrounds the environmental sensitive element; and
a filler disposed between the first substrate and the second substrate and covering the environmental sensitive element and the first barrier structure.

2. The package of the environmental sensitive element as claimed in claim 1, wherein the first barrier structure and the second substrate are made of stainless steel, glass, or plastic.

3. The package of the environmental sensitive element as claimed in claim 1, further comprising:
a second barrier structure disposed on the first substrate and surrounding the environmental sensitive element, wherein the second barrier structure and the first barrier structure are arranged alternately.

4. The package of the environmental sensitive element as claimed in claim 3, further comprising:
a first passivation layer disposed on the environmental sensitive element and the second barrier structure, wherein the first passivation layer covers the second barrier structure.

5. The package of the environmental sensitive element as claimed in claim 4, further comprising:
a getter layer disposed on the first passivation layer; and
a second passivation layer disposed on the getter layer, wherein the getter layer is located between the first passivation layer and the second passivation layer.

6. The package of the environmental sensitive element as claimed in claim 3, further comprising:
a flexible sacrificial layer disposed on the environmental sensitive element; and
a flexible passivation layer disposed on the flexible sacrificial layer and the second barrier structure, wherein the flexible sacrificial layer is located between the environmental sensitive element and the flexible passivation layer, and the flexible passivation layer covers the second barrier structure.

7. The package of the environmental sensitive element as claimed in claim 6, further comprising:
a plurality of passivation films disposed on the flexible passivation layer, wherein the passivation films are disposed on a portion of the flexible passivation layer on the second barrier structure.

8. A package of an environmental sensitive element, the package comprising:
a first substrate having a first barrier structure, wherein the first barrier structure and the first substrate are integrally formed and made of a same material;
a second substrate disposed above the first substrate, wherein the first barrier structure is located between the first substrate and the second substrate;
an environmental sensitive element disposed on the first substrate and located between the first substrate and the second substrate, wherein the first barrier structure surrounds the environmental sensitive element; and
a filler disposed between the first substrate and the second substrate and covering the environmental sensitive element and the first barrier structure.

9. The package of the environmental sensitive element as claimed in claim 8, wherein the first barrier structure and the first substrate are made of stainless steel, glass, or plastic.

10. The package of the environmental sensitive element as claimed in claim 8, further comprising:
a first passivation layer disposed on the environmental sensitive element and the first barrier structure, wherein the first passivation layer covers the first barrier structure.

11. The package of the environmental sensitive element as claimed in claim 10, further comprising:
a getter layer disposed on the first passivation layer; and
a second passivation layer disposed on the getter layer, wherein the getter layer is located between the first passivation layer and the second passivation layer.

12. The package of the environmental sensitive element as claimed in claim 8, further comprising:
a flexible sacrificial layer disposed on the environmental sensitive element; and
a flexible passivation layer disposed on the flexible sacrificial layer, wherein the flexible sacrificial layer is located between the environmental sensitive element and the flexible sacrificial layer.

13. The package of the environmental sensitive element as claimed in claim 12, further comprising:
a plurality of passivation films disposed on the flexible passivation layer and the first barrier structure, wherein the passivation films cover the first barrier structure.

14. The package of the environmental sensitive element as claimed in claim 8, further comprising:
a second barrier structure disposed on the second substrate and surrounding the environmental sensitive element, wherein the second barrier structure and the first barrier structure are arranged alternately.

15. An encapsulation method of an environmental sensitive element, the encapsulation method comprising:
forming an environmental sensitive element on a first substrate;
providing a second substrate having a first barrier structure, wherein the first barrier structure surrounds the environmental sensitive element, and the first barrier structure and the second substrate are integrally formed and substantially made of a same material;
forming a filler on the second substrate to cover the first barrier structure; and
pressing the second substrate onto the first substrate, such that the second substrate adheres to the first substrate through the filler and the filler covers the environmental sensitive element.

16. The encapsulation method of the environmental sensitive element as claimed in claim 15, wherein a method of providing the second substrate having the first barrier structure comprises:
providing a substrate, wherein the substrate is made of stainless steel or glass; and
performing an etching process to the substrate to form the second substrate and the first barrier structure located on the second substrate.

17. The encapsulation method of the environmental sensitive element as claimed in claim 15, wherein a method of providing the second substrate and the first barrier structure comprises:
providing a substrate, wherein the substrate is made of plastic; and
performing a molding process or a pressing process to the substrate to form the second substrate and the first barrier structure located on the second substrate.

18. The encapsulation method of the environmental sensitive element as claimed in claim 15, further comprising:
forming a second barrier structure on the first substrate after forming the environmental sensitive element on the first substrate, wherein the second barrier structure surrounds the environmental sensitive element and is arranged alternately with the first barrier structure.

19. The encapsulation method of the environmental sensitive element as claimed in claim 18, further comprising:
forming a first passivation layer on the environmental sensitive element and the second barrier structure after forming the second barrier structure on the first substrate, wherein the first passivation layer covers the second barrier structure.

20. The encapsulation method of the environmental sensitive element as claimed in claim 19, further comprising:
forming a getter layer on the first passivation layer after forming the first passivation layer; and
forming a second passivation layer on the getter layer after forming the getter layer, wherein the getter layer is located between the first passivation layer and the second passivation layer.

21. The encapsulation method of the environmental sensitive element as claimed in claim 18, further comprising:
forming a flexible sacrificial layer on the environmental sensitive element after forming the environmental sensitive element on the first substrate; and
forming a flexible passivation layer on the flexible sacrificial layer and the second barrier structure after forming the flexible sacrificial layer, wherein the flexible sacrificial layer is located between the environmental sensitive element and the flexible passivation layer, and the flexible passivation layer covers the second barrier structure.

22. The encapsulation method of the environmental sensitive element as claimed in claim 21, further comprising:
simultaneously forming a plurality of passivation films on the flexible passivation layer after forming the flexible passivation layer, wherein the passivation films cover a portion of the flexible passivation layer on the second barrier structure.

23. An encapsulation method of an environmental sensitive element, the method comprising:
providing a first substrate having a first barrier structure, wherein the first barrier structure and the first substrate are substantially made of a same material;
forming an environmental sensitive element on the first substrate, wherein the first barrier structure surrounds the environmental sensitive element;
forming a filler on the first substrate to cover the environmental sensitive element and the first barrier structure;
providing a second substrate on the first substrate; and
pressing the second substrate onto the filler.

24. The encapsulation method of the environmental sensitive element as claimed in claim 23, wherein a method of providing the first substrate having the first barrier structure comprises:
providing a substrate, wherein the substrate is made of stainless steel or glass; and
performing an etching process to the substrate to form the first substrate and the first barrier structure located on the first substrate.

25. The encapsulation method of the environmental sensitive element as claimed in claim 23, wherein a method of providing the first substrate having the first barrier structure comprises:
providing a substrate, wherein the substrate is made of plastic; and
performing a molding process or a pressing process to the substrate to form the second substrate and the first barrier structure located on the second substrate.

26. The encapsulation method of the environmental sensitive element as claimed in claim 23, further comprising:
forming a first passivation layer on the environmental sensitive element and the first barrier structure after forming the environmental sensitive element on the first substrate, wherein the first passivation layer covers the first barrier structure.

27. The encapsulation method of the environmental sensitive element as claimed in claim 26, further comprising:
forming an absorbent layer on the first passivation layer after forming the first passivation layer; and
forming a second passivation layer on the absorbent layer after forming the absorbent layer, wherein the absorbent layer is located between the first passivation layer and the second passivation layer.

28. The encapsulation method of the environmental sensitive element as claimed in claim 23, further comprising:
forming a flexible sacrificial layer on the environmental sensitive element after forming the environmental sensitive element on the first substrate; and
forming a flexible passivation layer on the flexible sacrificial layer after forming the flexible sacrificial layer, wherein the flexible sacrificial layer is located between the environmental sensitive element and the flexible sacrificial layer.

29. The encapsulation method of the environmental sensitive element as claimed in claim 28, further comprising:
forming a plurality of passivation films on the flexible passivation layer and the first barrier structure after forming the flexible passivation layer, wherein the passivation films cover the first barrier structure.

30. The encapsulation method of the environmental sensitive element as claimed in claim 23, further comprising:
forming a second barrier structure surrounding the environmental sensitive element on the second substrate after providing the second substrate, wherein the second barrier structure and the first barrier structure are arranged alternately.
